(19) United States
(12) Patent Application Publication
(10) Pub. No.: US 2006/0208511 A1
(43) Pub. Date: Sep. 21, 2006

(54) Pan lifting implement

(76) Inventors: Roy Romsburg, Hagerstown, MD (US); Paul Romsburg JR., Williamsport, MD (US); Paul Romsburg SR., Williamsport, MD (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/083,268

(22) Filed: Mar. 18, 2005

(51) Int. Cl. A47J 45/07

(52) U.S. Cl. 294/31.1

(57) ABSTRACT

An implement for lifting pans from steam tables. The implement includes a pair of pivotally connected, crisscrossing levers. A pair of jaws, each is affixed to the front end of a respective one of the levers and extends laterally beyond the opposite sides of a respective one of the levers. One of the jaws has a lifting plate from the middle of which a backstop extends upwardly and forwardly at an acute angle to form a concavity into which the outer edge of a rim of a pan can be inserted. The other one of the jaws has a shank portion that is positioned above the backstop and a hook portion that extends downwardly from the shank portion for grasping the inner edge of a rim of a pan.

### FIELD OF THE INVENTION

The present invention relates generally to tools with jaws positioned by relatively movable plural handles and, more particularly, to such tools with jaws that extend laterally beyond the side edge planes of the handles.

### BACKGROUND OF THE INVENTION

For decades, caterers and restaurateurs have confronted the problems associated with moving food-filled, serving pans to and from steam tables. These pans are typically hot, heavy and bulky, necessitating that they be handled with great care to avoid scalding. Furthermore, a lack of handles makes serving pans difficult to grasp, let alone lift and carry. Of course, a spill from a pan used at a steam table wastes food and can be time-consuming to clean.

An improvised method is normally used to dislodge a pan from a steam table. It may involve using a knife or fork as a prying tool to raise the lip of a pan from a steam table and, then, grasping the pan with towel-covered hands. Once grasped, the pan is toted to a kitchen for refilling or cleaning. Moving the pan back to the steam table requires a similar procedure, only the use of a prying tool is not required. Regardless of the direction of movement of the pan, however, the towel sometimes falls into it, contaminating food and making it unfit for human consumption.

### SUMMARY OF THE INVENTION

In light of the problems associated with the known practices associated with moving serving pans to and from steam tables, it is a principal object of the invention to provide an implement that permits a user to safely lift a serving pan from a hot well, steamer or food warmer and to transport the pan to any desired location. Use of the implement minimizes the likelihood of scalds, burns, pinched fingers and other lost time injuries.

Still another object of the invention is to provide an implement of the type described that firmly grips a pan as it is being lifted and carried so that the likelihood of embarrassing and costly food spills is minimized. Further, the implement impresses onlookers who see pans being lifted and carried in an expert manner.

It is another object of the invention to provide an implement of the type described that does not, in ordinary use, contact food in a serving pan, thereby minimizing the likelihood of food contamination. Thus, use of the implement promotes good sanitation practices.

It is an object of the invention to provide improved elements and arrangements thereof in a pan lifting implement for the purposes described that is lightweight in construction, inexpensive to manufacture, and dependable in use.

Briefly, the pan lifting implement in accordance with this invention achieves the intended objects by featuring a pair of pivotally connected, crisscrossing levers and a pair of jaws, each being affixed to the front end of a respective one of the levers and each extending laterally beyond the opposite sides of a respective one of the levers. One of the jaws has a lifting plate from the middle of which a backstop extends upwardly and forwardly at an acute angle so as to form a concavity into which the outer edge of the rim of a pan can be inserted. The other one of the jaws has a shank portion that is positioned above the backstop and a hook portion that extends downwardly from the shank portion for grasping the inner edge of the rim of a pan. A biasing mechanism normally retains the jaws in a spaced-apart, open condition.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a side view of a pan lifting implement in accordance with the present invention shown lifting a pan.

FIG. 2 is a perspective view of the pan lifting implement of FIG. 1.

FIG. 3 is a bottom view of the pan lifting implement.

FIG. 4 is a front view of the pan lifting implement.

FIG. 5 is a rear view of the pan lifting implement.

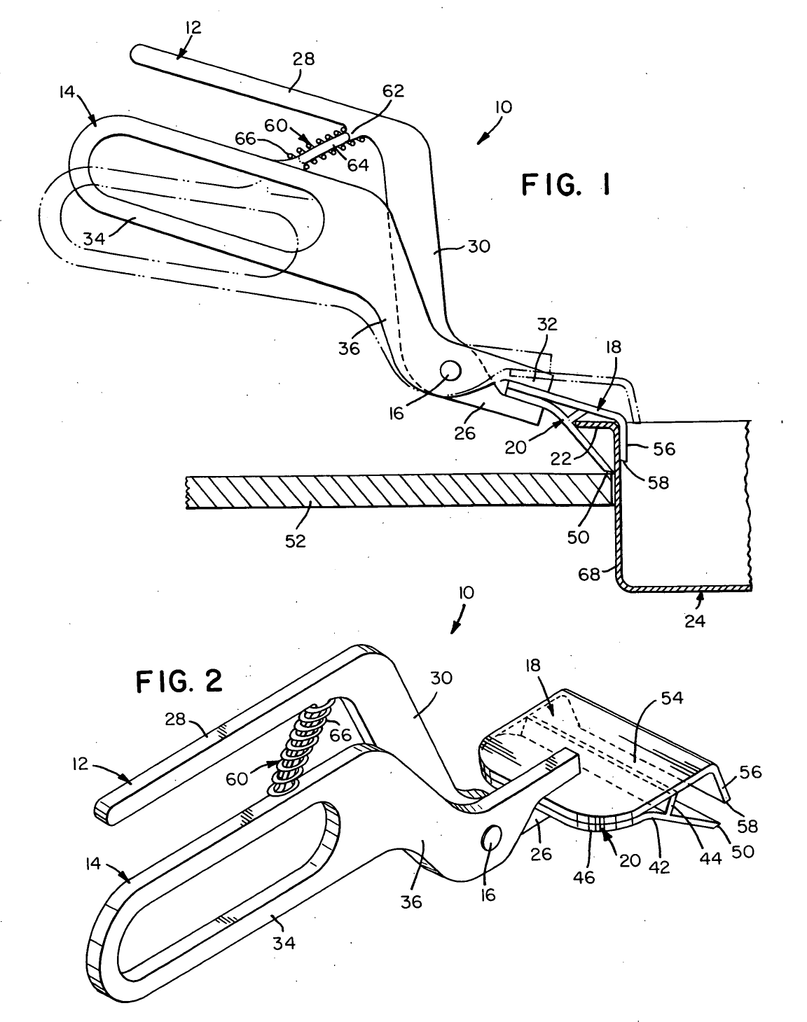

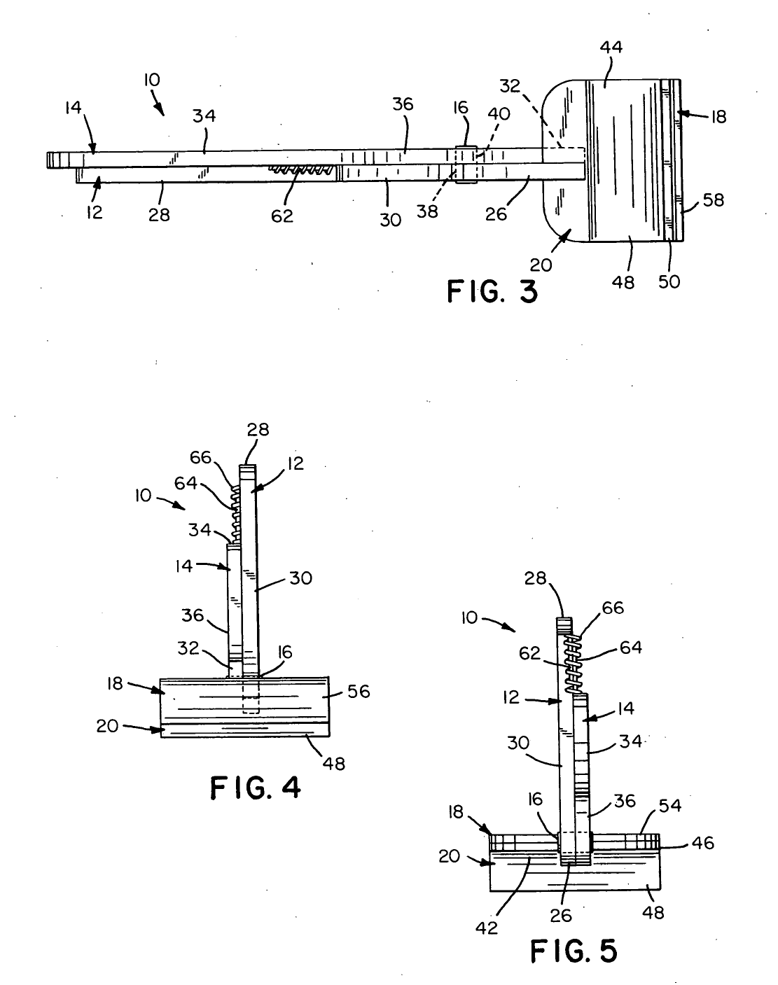

Similar reference characters denote corresponding features consistently throughout the accompanying drawings.

### DETAILED DESCRIPTION OF THE PREFERRED EMBODIMENT

Referring now to the FIGS., a pan lifting implement in accordance with the present invention is shown at 10. Implement 10 includes a pair of levers 12 and 14 connected together by a pivot pin 16 in the crisscrossing manner of pliers. Levers 12 and 14 carry a pair of jaws 18 and 20 for grasping the peripheral rim 22 of a pan 24.

Lever 12 has a keeper portion 26 at its front end and a handle portion 28 at its rear end joined together by a crosspiece 30. Keeper portion 26 and handle portion 28 are bars that are vertically offset so that keeper portion 26 has a lower elevation than that of handle portion 28 during normal usage of implement 10. Crosspiece 30 joins keeper portion 26 and handle portion 28 at obtuse angles to maintain the offset relationship between keeper portion 26 and handle portion 28.

Lever 14 has a keeper portion 32 at its front end and a handle portion 34 at its rear end joined together by a crosspiece 36. Keeper portion 32 is a bar having a length substantially equal to that of keeper portion 26. Handle portion 34, however, is an elongated loop having a length that is substantially the same as that of handle portion 28 and is otherwise sized to receive the fingers of a user's hand. Handle portion 34 is vertically offset from keeper portion 32 so that it is normally higher than keeper portion 32 during usage of implement 10. Crosspiece 36 is about half as long as crosspiece 30 and joins keeper portion 32 and handle portion 34 together at obtuse angles.

Crosspieces 30 and 36 are provided with transverse apertures 38 and 40 at their front/bottom ends. With apertures 38 and 40 in registry with one another, pivot pin 16 is extended through apertures 38 and 40. Pivot pin 16 connects levers 12 and 14 together and maintains such in a crisscrossing relationship. The crisscrossing relationship involves crosspieces 30 and 36 crossing one another with the front end of crosspiece 36 being elevated above the front end of crosspiece 30. Additionally, the crisscrossing of levers 12 and 14 keeps keeper portion 32 elevated above keeper portion 26 and handle portion 28 elevated above handle portion 34.

The lower jaw 20 comprises a lifting plate 42 from the midpoint of which a backstop 44 extends upwardly. Lifting plate 42 has a base portion 46 at its rear that is affixed to the top of keeper portion 26 of lever 12 and a wedge portion 48 that projects forwardly and downwardly from the front of base portion 46. A beveled edge 50 defines the front of wedge portion 48 and permits wedge portion 48 to be easily inserted under the rim 22 of pan 24 seated upon a steam table 52. As shown, backstop 44 extends upwardly and forwardly from wedge portion 48 near its junction with base portion 46 at an acute angle so as to form a concavity into which rim 22 can be inserted. The top of backstop 44 engages the bottom of upper jaw 18 when handle portions 28 and 34 are squeezed together to minimize the likelihood that rim 22 may move freely between jaws 18 and 20 once grasped by them.

Upper jaw 18 is hook-shaped, having a shank portion 54 at its rear that is affixed to the bottom of keeper portion 32 of lever 14 and a hook portion 56 that projects forwardly and downwardly from the front of shank portion 54. The front of hook portion 56 is defined by a free edge 58 that is positioned closely adjacent to beveled edge 50 of lower jaw 20 when handle portions 28 and 34 are fully squeezed together such that backstop 44 engages shank portion 54 proximate its midpoint.

Implement 10 is provided with a biasing mechanism 60 that retains jaws 18 and 20 in a normally open relationship as indicated by broken lines in FIG. 1 for easy engagement with pan 24. Biasing mechanism 60 includes a pair of arcuate stems 62 and 64 being respectively affixed to lever 12 and lever 14 and a compressed spring 66 coiled about stems 62 and 64. Specifically, stem 62 extends downwardly from the front of handle portion 28 and stem 64 upwardly from the front of handle portion 34 so as to slide past one another when levers 12 and 14 are reciprocated. The radius of curvature of stems 62 and 64 is equal to their distance from pivot pin 16 to prevent their binding against spring 66. So that spring 66 does not become lost during use of implement 10, its opposed ends can be secured by welding or otherwise to handle portions 28 and 34.

Use of pan lifting implement 10 is straightforward. First, with serving pan 24 positioned on steam table 52 and jaws 18 and 20 in their normally open position, beveled edge 50 is slid beneath rim 22 and engaged with the side wall 68 of pan 24. Then, handle portions 28 and 34 are elevated from steam table 52 to partially lift pan 24 and drive the free edge of rim 22 into the concavity formed between the wedge portion 48 and backstop 44 of lower jaw 20. Next, handle portions 28 and 34 are squeezed together to position upper jaw 18 over rim 22 as illustrated by the solid line positioning in FIG. 1. Now, with hook portion 56 of jaw 18 positioned within pan 24 and against side wall 68 and shank portion 54 atop rim 22, pan 24 can be fully lifted and carried anywhere. The entire lifting process requires only a few seconds to complete.

When pan 24 has been carried to a desired location, a user releases handle portions 28 and 34. With no resisting force, spring 66 moves jaws 18 and 20 apart thereby freeing implement 10 from pan 24. Implement 10 can now be immediately reused if circumstances require or set aside for use at a later time. Because of its compact size, implement 10 can be conveniently stored in a drawer or other convenient location. Should implement 10 ever contact food during use, it can be easily washed with soap and water.

While pan lifting implement 10 has been described with a high degree of particularity, it will be appreciated by those skilled in the art that modifications can be made to it. Therefore, it is to be understood that the present invention is not strictly limited to pan lifting implement 10 described above, but encompasses any and all embodiments of a pan lifting implement within the scope of the following claims.

We claim:

1. A pan lifting implement, comprising:
a pair of pivotally connected, crisscrossing levers; and,
a pair of jaws, each being affixed to the front end of a respective one of said levers and extending laterally beyond the opposite sides of a respective one of said levers,
one of said jaws including a lifting plate from the middle of which a backstop extends upwardly and forwardly at an acute angle so as to form a concavity into which the outer edge of the rim of a pan can be inserted; and,
the other one of said jaws including a shank portion being positioned above said backstop and a hook portion extending downwardly from said shank portion for grasping the inner edge of the rim of a pan.

2. A pan lifting implement, comprising:
a first lever including a first keeper portion at the front end thereof and a first handle portion at the rear end thereof being joined together by a first crosspiece, said first keeper portion and said first handle portion being vertically offset so that said first keeper portion has a lower elevation than that of said first handle portion;
a second lever including a second keeper portion at the front end thereof and a second handle portion at the rear end thereof being joined together by a second crosspiece, said second keeper portion and said second handle portion being vertically offset so that said second keeper portion has a lower elevation than that of said first handle portion, said second crosspiece being about half as long as said first crosspiece;
a pivot pin passing through said first crosspiece and said second crosspiece so as to pivotally connect said first lever and said second lever together;
a first jaw being affixed to said first keeper portion of said first lever and extending laterally beyond the opposite sides of said first lever, said first jaw including a lifting plate from the middle of which a backstop extends upwardly and forwardly at an acute angle so as to form a concavity into which the outer edge of the rim of a pan can be inserted; and,
a second jaw being affixed to said second keeper portion of said second lever and extending laterally beyond the opposite sides of said second lever, said second jaw including a shank portion being positioned above said backstop and a hook portion extending downwardly from said shank portion for grasping the inner edge of the rim of a pan.

3. A pan lifting implement, comprising:
a first lever including a first keeper portion at the front end thereof and a first handle portion at the rear end thereof being joined together by a first crosspiece, said first keeper portion and said first handle portion being vertically offset so that said first keeper portion has a lower elevation than that of said first handle portion;
a second lever including a second keeper portion at the front end thereof and a second handle portion at the rear end thereof being joined together by a second crosspiece, said second keeper portion and said second handle portion being vertically offset so that said second keeper portion has a lower elevation than that of said first handle portion, said second crosspiece being about half as long as said first crosspiece;
a pivot pin passing through said first crosspiece and said second crosspiece so as to pivotally connect said first lever and said second lever together;
a first jaw being affixed to said first keeper portion of said first lever and extending laterally beyond the opposite sides of said first lever, said first jaw including a lifting plate from the middle of which a backstop extends upwardly and forwardly at an acute angle so as to form a concavity into which the outer edge of the rim of a pan can be inserted;
a second jaw being affixed to said second keeper portion of said second lever and extending laterally beyond the opposite sides of said second lever, said second jaw including a shank portion being positioned above said backstop and a hook portion extending downwardly from said shank portion for grasping the inner edge of the rim of a pan; and,
a biasing mechanism for normally retaining said first jaw and said second jaw in a spaced-apart, open condition, said mechanism including:
a first arcuate stem extending downwardly and rearwardly from said first handle portion;
a second arcuate stem extending upwardly and forwardly from said second handle portion closely adjacent to said first arcuate stem; and,
a compressed spring coiled about said first arcuate stem and said second arcuate stem.
